(19) United States
(12) Patent Application Publication
(10) Pub. No.: US 2019/0137010 A1
(43) Pub. Date: May 9, 2019

(54) One-Piece Rooftop Pipe Supports

(71) Applicant: INTEGRATED COMFORT, INC., West Sacramento, CA (US)

(72) Inventors: Richard Curtis Bourne, Davis, CA (US); Jonathan Clement Bourne, Madison, WI (US)

(73) Assignee: INTEGRATED COMFORT, INC., West Sacramento, CA (US)

(21) Appl. No.: 15/805,624

(22) Filed: Nov. 7, 2017

(51) Int. Cl. F16L 3/18; F16L 3/12; F16L 3/20; F24F 13/02

(52) U.S. Cl. CPC F16L 3/18; F16L 3/1222; F24F 13/0254; F16L 3/20; F16L 3/1218

(57) ABSTRACT

This invention provides simple, low-cost designs for rooftop support of pipes on low-slope commercial and industrial roofs. The designs use cut pieces of extruded plastic shapes with holes or slots transverse to the extrusion direction. The supports are designed to be lightly adhered to the roof, and to allow pipe movement for expansion and contraction.

### TECHNICAL FIELD

### BACKGROUND ART

Piping is often run atop and across flat and low-slope roofs to serve HVAC and refrigeration devices. These pipes may be used to supply gas or water, or to drain condensate or evaporative “bleed” or “purge” water to drains. Steel, copper, and polymeric piping are commonly used in these applications. These pipes are supported above the roof surface to provide clearance beneath them for rainwater and debris. Historically the pipes have rested on wooden support blocks to which they are secured with metal pipe clamps. Depending on system weight, they may or may not be secured to the roof surface with a mastic or, on “single-ply” polymeric roof sheets, with a wrapping membrane that is compatible with the roof membrane. Over time these wood-based support blocks dry and age such that they need replacement. Also, the plastic-wrapped variants are quite costly.

More recently, new, more permanent support block designs have emerged that do not use wood. Examples are seen in U.S. Pat. Nos. 6,364,256, 6,682,025, 7,735,270, 8,356,778, and 8,540,194. The Olle patent (U.S. Pat. No. 7,735,270) shows a design now in use that uses a heavy, solid rubber block with a slot in which a strut-type clamp system inserts, while the Miro patent (U.S. Pat. No. 6,364,256) shows a complex design that has not been commercialized. The Birli patent (U.S. Pat. No. 8,356,778) is the most interesting of these, in its combination of two extruded shapes to provide flexibility as to pipe size and mounting height. The Turner patent (U.S. Pat. No. 6,682,025) discloses a one-piece extrusion that is not adjustable for pipe size. This design includes in its profile a “partial circle” recess that clips securely onto the pipe, with the mounted pipe extending along the direction of extrusion of the one-piece support. This design is likely the least-costly in the prior art, but it does not allow a single extrusion to be used for multiple pipe sizes, nor does it allow pipes to slide for expansion and contraction when the support is secured to the roof. The Azuma patent (U.S. Pat. No. 8,540,194) uses a hollow plastic extrusion with slots into which strut-type pipe clamps may be secured.

### SUMMARY OF THE INVENTION

### Technical Problem

This invention responds to the short life of traditional rooftop pipe supports, the high cost of other newer, longer-life designs, and the need for long straight runs where the supports are adhered to the roof and the supported pipes can move freely in their supports under the forces of thermal expansion and contraction.

### Solution to Problem

The polymeric extruded shapes presented here, with pipe support holes and open-top cuts transverse to the extrusion direction, provide excellent long-term pipe support, with free movement of the supported pipes, at lower initial and installation costs compared to the prior art.

### Advantageous Effects of Invention

Rooftop pipe support cost becomes a significant issue in the context of rising metal costs, which are causing a shift to polymeric pipes in appropriate applications. Copper water supply and drainage pipes are increasingly subject to theft and thus are being replaced by wrapped, painted, or UV-resistant PVC pipes, but due to its lower strength, PVC requires more closely-spaced supports, which increases support system cost. Also, polymeric pipes experience much more thermal expansion and contraction than metal pipes, thus requiring more attention with the support system to accommodate pipe movement. This invention provides simple, one-piece, UV-resistant pipe supports that:

1. Significantly reduce installed costs

2. Allow pipes to slide in the support as they expand and contract

3. Install quickly and easily without tools

4. Do not need metallic or other specialty parts to clamp pipes to supports

5. Can easily be secured to roof surfaces with mastic/adhesive

6. Can be removed without harming the roof surface

7. Withstand the rigors of weather for the piping or roof surface lifetime.

### BRIEF DESCRIPTION OF DRAWINGS:

FIG. 1 shows an isometric view of an example pipe support in accordance with the present invention. Hollow square extrusion block 1 is cut from an approximately 4″ square hollow extrusion profile and is approximately 4″ long in the extrusion direction. Designed to support a 1″ PVC pipe 5 with 1.315″ diameter, the support has opposed holes 2 centered along the 4″ length and located just below the top surface 3. The diameter of holes 2 is larger than the pipe (−1.35″) to allow pipe movement in the support, typically caused by thermal expansion and contraction. The flat bottom surface 4 rests on the roof surface 6 to which it is secured by a small dab of mastic. While the block 1 could have straight (vertical) cross-cuts from the extrusion profile, the cross-cut sides 7 shown in FIG. 1 are opposed diagonals to produce more units per linear foot of extrusion. That is, the goal is to have a wide stable bottom surface 4, while using enough of the extrusion to securely retain the pipe 5 above the roof surface 6. The diagonal cut strategy allows the top of the block 1 to be narrower than the bottom, reducing the average length of each block and thus its cost.

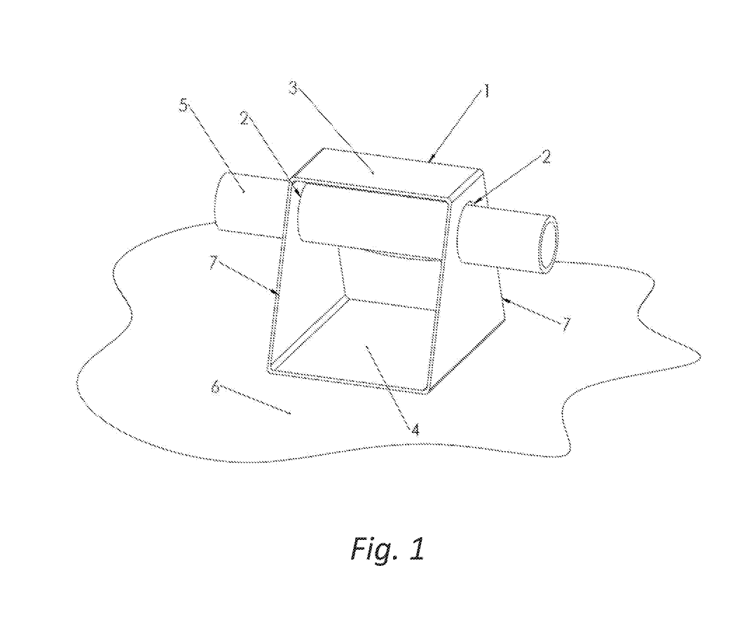

FIG. 2A shows an isometric view of a triangular extrusion similar in design to FIG. 1 in terms of overall “bounding box” dimensions, thickness, and method of roof attachment. The advantages of the triangular extrusion profile are reduced material per unit, and greater structural rigidity when compared to the rectangular profile shown in FIG. 1. FIG. 2B shows an elevation view of the same unit viewed “through the pipe.” This embodiment shows an option that allows the supports to be installed on existing pipes. The hole 2 breaks through the top 3 of the extrusion 1 such that the width of the opening 7 is slightly narrower than the diameter of the pipe 5. Since the polymeric support block material is somewhat flexible, this feature allows the support block to be forced onto the existing pipe while limiting the likelihood that the pipe separates from the support under rooftop conditions. As with FIG. 1, the hole 2 is slightly larger than the diameter of the pipe 5 to facilitate pipe movement. The “hole breakout” feature shown in FIG. 2 could also be used on the rectangular profile in FIG. 1, just as the through-holes shown in 1 could be used on the triangular profile in FIG. 2.

FIG. 3 shows an isometric view of an alternate extrusion configuration for new construction as well as retrofit use on existing pipes. This support has an open profile that requires a greater extrusion thickness than shown in FIGS. 1 and 2 to maintain rigidity, especially at angle 8. The primary advantage of the profile shown in FIG. 3 over the other options is that it allows the supports to nest easily for more efficient transport while maintaining the same ease of installation. As in the prior embodiments, the support 1 includes a bottom plane 4 adhered to a roof surface 6. But in this profile, the vertical plane 10 is connected to the bottom plane 4 by the sloping plane 9 that extends at an acute angle 8 so that the vertical plane 10 can be approximately centered over the bottom plane 4. In this manner the weight of the supported pipe 5 can be distributed evenly over the bottom plane 4. The acute angle 8 can be as little as 45 degrees while still allowing valuable “nesting” for efficient packing and shipping.

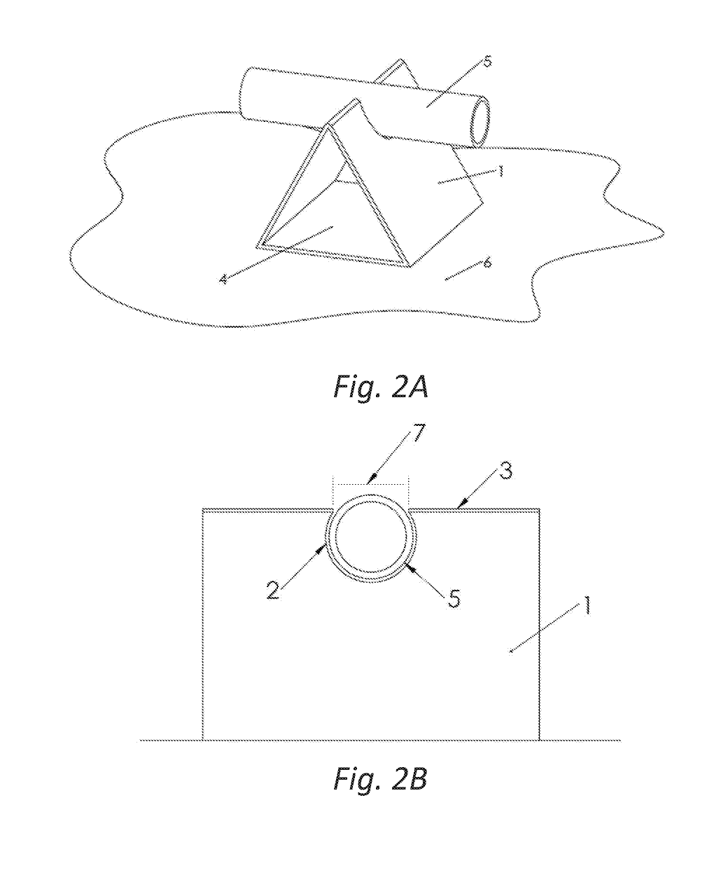

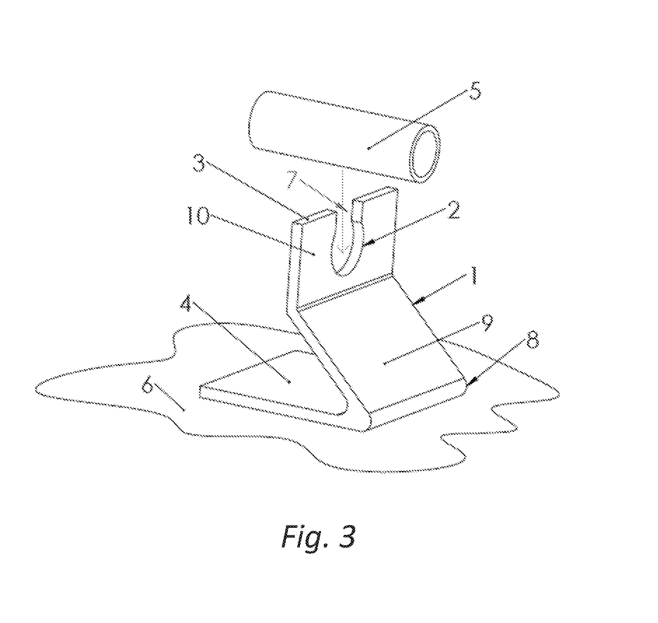

Much like the “breakout” shown in FIG. 2, the slot 2 of FIG. 3 breaks through the top 3 of the support 1 such that the width of the opening 7 is slightly narrower than the diameter of the pipe 5, allowing the pipe 5 and the support 1 to be forced into a mated configuration. The increased depth of the slot in FIG. 3 compared to the slot shown in FIG. 2B creates more secure retainage between the mated components. However, this slot configuration requires more complex production tooling compared to the FIG. 2 configuration, where a single cylindrical hole breaks through the top line 3.

A significant advantage of these designs is the speed of field placement. It is not necessary to place and tighten clamps as with most other rooftop pipe support designs and products. Securing to the rooftop with mastic or adhesive facilitates straight-line retention of long pipes without endangering the roof surface, since the pipes can move freely in the support blocks. This is a particular advantage when used on roofs with single-ply membranes.

The dimensions of the support extrusions and support holes described here may vary as to width, height, and length depending on pipe sizes and weights supported. Wall thickness of the extruded shapes may also vary with loading conditions. Multiple pipes may be held in a single support, typically with the support's length extended in the extrusion direction.

Although the invention has been described with reference to various exemplary embodiments and their combinations of features, the invention extends to the other possible combinations of the described features, as summarized in the claims that follow.

1-7. (canceled)

8. A support for securing a pipe on a rooftop, comprising:
a one-piece, three-dimensional shape formed by cross-cutting a polymeric extrusion, the three-dimensional shape comprising:
a top;
a flat bottom surface configured for engagement with a roof surface; and
a side surface disposed between the top and the flat bottom surface; and
an opening disposed at least partially through the side surface and configured to receive a pipe therethrough, the opening aligned substantially orthogonal to an extrusion direction of the polymeric extrusion.

9. The support of claim 8, wherein the opening is sized and shaped to allow for movement of the pipe when the pipe is disposed through, and secured within, the opening.

10. The support of claim 9, wherein the opening is sized and shaped to allow for movement of the pipe caused by thermal expansion and contraction.

11. The support of claim 8, wherein a cross-section of the three-dimensional shape defines a rectangle.

12. The support of claim 8, wherein a cross-section of the three-dimensional shape defines a triangle.

13. The support of claim 8, wherein one or more edges of the side surface is at a diagonal relative to the flat bottom surface.

14. The support of claim 13, wherein the three-dimensional shape is formed by cross-cutting the polymeric extrusion at a non-90-degree angle.

15. The support of claim 8, wherein the opening is disposed entirely within the side surface such that the pipe has to be inserted through the opening from the side.

16. The support of claim 8, wherein the opening extends into the top of the three- dimensional shape thereby forming a cutout in the top.

17. The support of claim 16, wherein the cutout formed in the top includes a width that is narrower than a diameter of the pipe.

18. The support of claim 17, wherein a polymeric material of the three-dimensional shape includes a flexibility selected such that the width of the cutout can be temporarily expanded to receive the pipe in the opening.

19. The support of claim 8, wherein the side surface includes a vertical plane disposed adjacent to the top and a sloping plane connecting the vertical plane to the bottom surface of the three-dimensional shape.

20. The support of claim 19, wherein a cross-section of the three-dimensional shape is selected to permit nesting of a plurality of three-dimensional shapes.

21. The support of claim 8, wherein the three-dimensional shape includes two side surfaces, each of the two side surfaces having an opening disposed therethrough.

22. The support of claim 8, further comprising an adhesive on the flat bottom surface configured to secure the flat bottom surface to a single-ply roof membrane.

23. The support of claim 22, wherein the adhesive includes mastic.

24. A support for securing a pipe on a rooftop, comprising:
a one-piece, three-dimensional shape formed by cross-cutting a hollow polymeric extrusion, the three-dimensional shape comprising:
a top;
a flat bottom surface configured for engagement with a roof surface; and
at least two side surfaces disposed between the top and the flat bottom surface;
and
an opening disposed at least partially through each of the at least two side surfaces, each opening configured to receive a pipe therethrough, and each opening aligned substantially orthogonal to an extrusion direction of the hollow polymeric extrusion.

25. The support of claim 24, wherein a cross-section of the three-dimensional shape defines one or more of a rectangle and a triangle.

26. A support for securing a pipe on a rooftop, comprising:
a one-piece, three-dimensional shape formed by cross-cutting a polymeric extrusion, the three-dimensional shape comprising:
a flat bottom surface configured for engagement with a roof surface;
a sloping plane extending from the flat bottom surface; and
a vertical plane extending from the sloping plane; and
an opening disposed at least partially through the vertical plane and configured to receive a pipe therethrough, the opening aligned substantially orthogonal to an extrusion direction of the polymeric extrusion.

27. The support of claim 26, wherein the opening extends into a top edge of the vertical plane thereby forming a cutout in the top edge, wherein the cutout includes a width that is narrower than a diameter of the pipe, and wherein a polymeric material of the three-dimensional shape includes a flexibility selected such that the width of the cutout can be temporarily expanded to receive the pipe in the opening.
